(19) United States
(12) Patent Application Publication
(10) Pub. No.: US 2002/0079346 A1
(43) Pub. Date: Jun. 27, 2002

(54) Adhesive-tape feeder

(76) Inventor: Teng-Chi Yu, Taichung (TW)

Correspondence Address: DOUGHERTY & TROXELL, 5205 LEESBURG PIKE, SUITE 1404, FALLS CHURCH, VA, 22041, US

(21) Appl. No.: 09/745,466

(22) Filed: Dec. 26, 2000

(51) Int. Cl. B26F 3/02

(52) U.S. Cl. 225/57; 225/39; 225/65

(57) ABSTRACT

An adhesive-tape feeder includes a support plate positioned between inner walls of two support stands, and guide plates under the support plate to form a guide groove of a certain width between the guide plates and the support plate for a adhesive tape to pass through. Besides, under the support plate is provided with an upper projection between two guide plates which respectively have a lower projection on a top center, positioned not to face the upper projection so as to let the adhesive-tape rest therein in a wavy shape to avoid rolling back. Further, the inserting member of one support stand is firmly engaged with the inserting groove of the other support stand to fix together the two support stands firmly not to deform or disfigure.

### BACKGROUND OF THE INVENTION

This invention relates to a adhesive-tape feeder, particularly to one possible to prevent a coil adhesive tape from rolling back, and enable two support stands to be combined together stably by mutual engagement.

A conventional adhesive-tape feeder 10, as shown in FIG. 1 and 2, includes a knife-blade holder 11, a support plate 114, two support stands 12 and two support semi-circular walls 122 fixed on inner walls of the two support stands 12.

The knife-blade holder 11 is provided with a groove 111 in a front end for receiving knife-blades 115, and two guide grooves 112 positioned behind the groove 111, having two guide plates 113 positioned under the guide grooves 112. A support plate 114 is positioned behind the guide grooves 112, and the front portions of two support stands 12 are fixed with both sides of the support plate 114 and extend backward forming two arc-shaped fixing side walls 121 for restricting both sides of a coil adhesive-tape, and have the adhesive-tape inserting walls 122 for the coil adhesive-tape to fit in. The conventional adhesive-tape feeder has the following defects.

1. After the adhesive-tape is fitted with the inserting walls 122 of the two support stands 12, the tape end 132 is to pass through the guide groove 112, held by the guide plate 113 and pulled forward to adhere to something, and then, after finishing adhering, cut off by the knife-blade 115, leaving the tape end lying on the guide plate 113 not held by any components. As a result, the tape end is liable to roll back by careless turning of the coil adhesive tape, wasting much time in case of using it again.

2. Two support stands 12 are combined only by fixing their front portions with each side 116 of the knife-blade holder 11, so that it is easy to become twisted or deformed in the process of operating, and, if worse, fall off, thus causing much inconvenience to adhering work and lessening efficiency.

### SUMMARY OF THE INVENTION

The objective of the invention is to offer an adhesive-tape feeder, possible to prevent the adhesive tape from rolling back and two support stands from twisted and deformed.

One feature of the invention is an upper projection under a press plate and two lower projections on the guide plate positioned not facing two upper projections for the purpose of keeping the adhesive tape in a wavy shape to prevent it from rolling back.

Another feature of the invention is two support stands combined together by mutual engagement of an inserting plate of one support stand and the inserting groove of the other support stand to let the projection on the inserting plate insert into the recess in the inserting groove and stuck therein to stabilize two support stands.

### BRIEF DESCRIPTION OF THE DRAWINGS

This invention will be better understood by referring to the accompanying drawings, wherein:

FIG. 1 is a perspective view of a known conventional adhesive-tape feeder:

FIG. 2 is side cross-sectional view of the known conventional adhesive-tape feeder:

FIG. 3 is perspective view of an adhesive-tape feeder in the present invention:

FIG. 4 is a perspective view of the upper and lower projections of the adhesive tape in the present invention:

FIG. 5 is a perspective view of a separating condition of an inserting plate of one support stand and the inserting groove of the other support stand of the adhesive tape in the present invention:

FIG. 6 is a perspective view of a combined condition of the two inserting plates of the adhesive tape in the present invention:

FIG. 7 is side cross-sectional view of the adhesive tape pulled out for to be adhered on something the present invention.

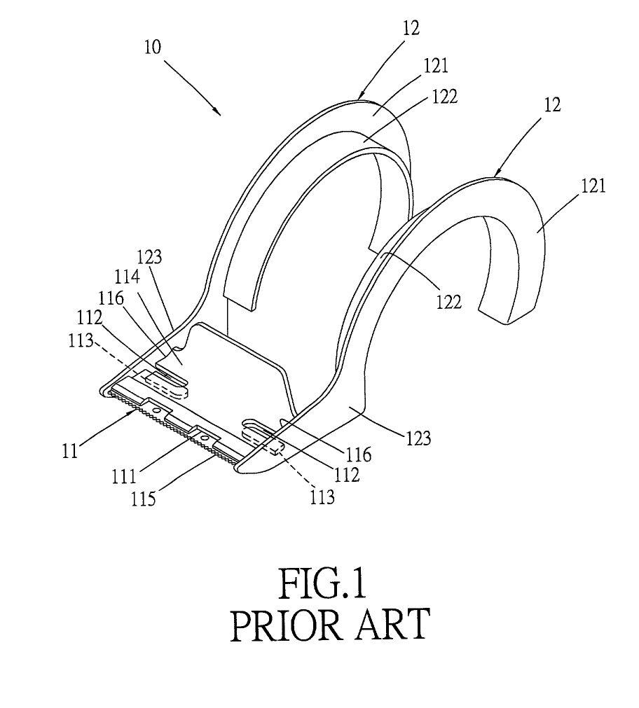

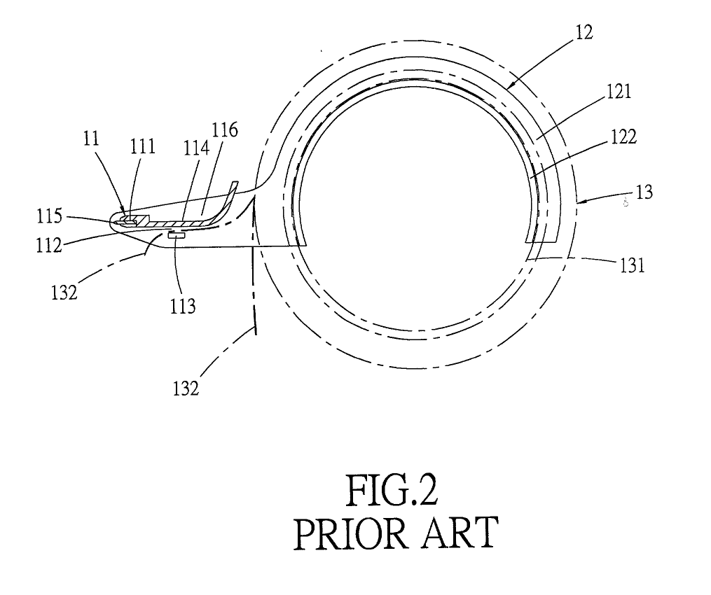

### DETAILED DESCRIPTION OF THE PREFERRED EMBODIMENT

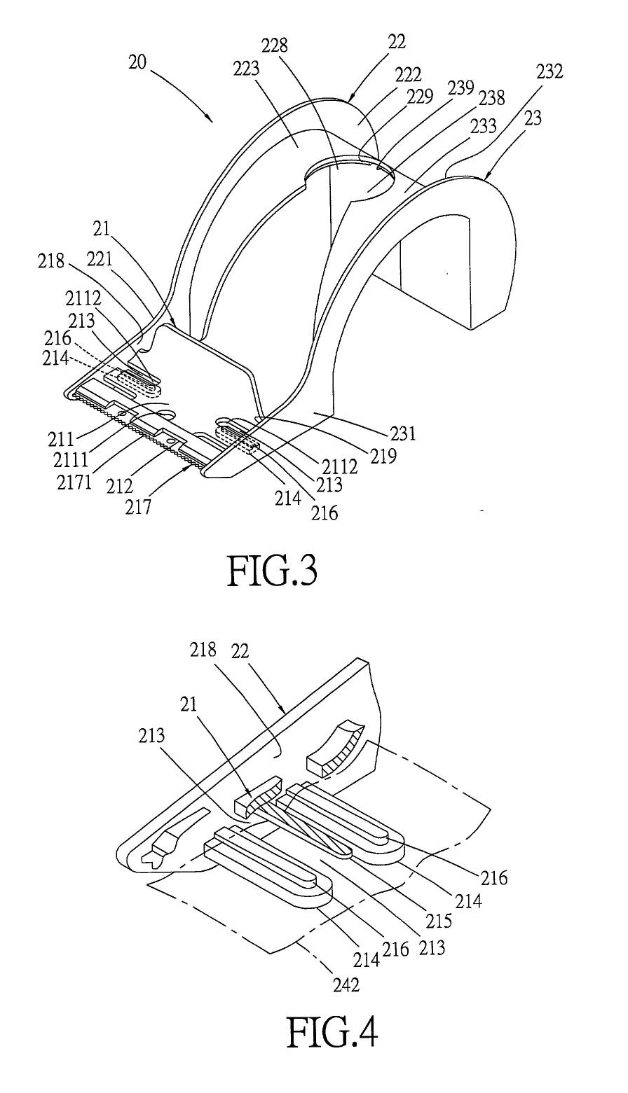

A preferred embodiment of an adhesive-tape feeder in the present invention, as shown in FIG. 3, includes a support plate 21 and two support stands 22, 23 made integral of plastics.

The front portion of the support plate 21 is formed into a press plate 211 having a groove 212 in the front portion, four guide grooves 2 1 3 in both sides, four guide plates 214 under the guide grooves 212 and knife-blade holder 217 at the front side end.

The front portions 221, 231 of the two support stands 22,23 are oppositely fixed with two sides 218, 219 of the support plate 21 to restrict both side of the adhesive tape. Besides, the two support stands 22, 23 are respectively composed of a fixing sidewall 222, 232 and a support plate 223, 233. The two fixing side-walls 222, 232 are shaped semi-circular, and the two support stands 22, 23 are respectively fixed under the fixing side-walls 222, 232 which extend to bend inward to form the arc-shaped support plates 223, 233 for receiving a center hole of a coil adhesive tape.

Further, the front portion of the support plate 21 has a plane surface, while the rear portion thereof is shaped upward parabolic, positioned at the front portion between two support stands 22, 23, and provided at the front portion with a press plate 211 which has a knife-blade holder 217 at front end, a hang hole 2111 in the center, two slots 2112 in each side, and two symmetrical upper projections 215 on the bottom surface.

The guide plates 214, as shown in FIG. 4, are respectively positioned at the front end of an inner side of the two support stands 22, 23 and exactly under the slots 2112 of the support plate 21, and a guide groove 213 is formed between the support plate 21 and the guide plates 214 for an adhesive tape to pass through. In addition, a lower projection 216 is respectively disposed on each guide plate 214, positioned not facing the upper projections 215.

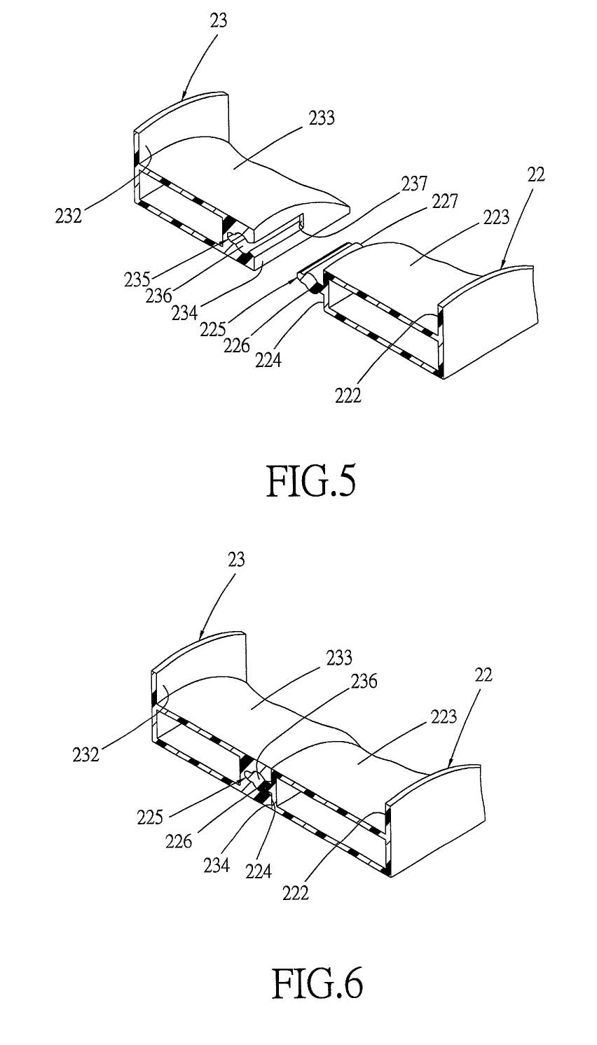

Furthermore, the joint side surface 224 of one of the support stands 22, as shown in FIG. 5 and 6, is provided with a protruding-out inserting member 225 having in center portion a lengthwise projection 226 with both ends protruding out, while the joint side 234 of the other support stand 23 is provided, correspondingly to the inserting member 225, with an inserting groove 235 having a lengthwise recess 236 inside with both ends dented to fit with the lengthwise projection 226 of the inserting member 225. When the inserting member 225 and the inserting groove 235 are engaged with each other, the projection 226 will engage in the recess 236 to let an upper outward end 227 stuck by the restricting plate 237 of the inserting groove 235 not to move up any more so as to stabilize the two support stands 22, 23.

Besides, as shown in FIG. 3, the upper portion of each support plate 223, 233 is provided with a curved opening 228, 238 having a flange 229, 239 disposed around a lower circumferential edge for convenience of separating two support stands 22, 23 from each other.

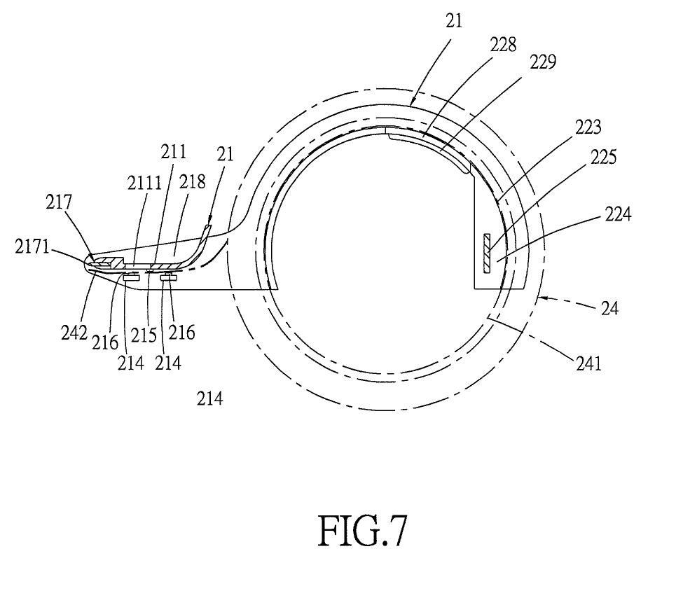

In using, as shown in FIG. 7, a coil adhesive-tape 24 is positioned in the feeder, with its center hole fitting with the inserting plate 223, 233 of the support stands 22, 23 to let the adhesive tape 24 positioned between the two fixing side-wall 222, 232, and then combine two support stands 22, 23 fixedly by engaging the inserting member 225 with the inserting groove 235. Then, the adhesive-tape end portion passes through under the upper projection 215 of the support plate 21 and over the lower projection 216 of the guide plate 214 to be positioned therein in a wavy shape. Normally, the adhesive-tape end portion 242 naturally falls down and adheres to the lower projection 216 of the guide plate 214, preventing it from rolling back.

The adhesive-tape feeder in the invention always hold a tape end adhered on the lower projection, unable to roll back, wasting no time in pulling out the tape for use. And the two support stands do not disfigure or twist by means of the inserting grooves engaging the inserting members, permitting the tap move out smoothly, and thus enhancing work efficiency with an advantage of industrial utilization.

While the preferred embodiment of the invention has been described above, it will be recognized and understood that various modifications may be made therein and the appended claims are intended to cover all such modifications that may fall within the spirit and scope of the invention.

I claim

1. An adhesive-tape feeder made integral of plastics comprising:
A knife-blade holder, a support plate, four guide plates and two support stands:
Said support plate positioned between a front portion of said two support stands; a front portion of said support plate formed into a press plate having a rear portion extending up in a parabolic shape:
Said press plate having a hang hole in a center, two opposite slots in both sides and two opposite upper projections on two sides of a bottom surface:
Said four guide plates located in a front end portion of inner sides of said two support stands and under said slots of said support plate, having plural lower projections on an upper surface positioned not to face said upper projections of a lower side of said support plate:
Said two support stands fixed with both sides of said support plate for restricting both sides of said adhesive-tape, respectively composed of a fixing side frame and an inserting member; said inserting member fixed on an inner wall of said fixing side-wall for receiving the center hole of said adhesive tape, a joint side surface of one of said support stands provided with a protruding-out inserting member having a lengthwise project ion in a central portion, a joint side surface of the other of said two support stands bored with an inserting groove having a recess inside for engaging with said lengthwise projection to fix said two support stands stabilized.

2. The adhesive-tape feeder as claimed in claim 1, wherein said inserting member of one of said support stand is provided on top center with said lengthwise projection with both ends protruding out, and in a center of said inserting groove is bored a lengthwise recess with both ends dented for receiving said lengthwise projection of said inserting member.

3. The adhesive-tape feeder as claimed in claim 1, wherein an upper portion of each said support stand is provided with an arc-shaped opening which has a flange disposed around a lower circumferential edge for convenience of separating said two support stands.
